(19) United States
(12) Patent Application Publication
(10) Pub. No.: US 2025/0343335 A1
(43) Pub. Date: Nov. 6, 2025

(54) SYSTEMS FOR A BATTERY SYSTEM

(71) Applicant: Ford Global Technologies, LLC, Dearborn, MI (US)

(72) Inventors: Francisco Fernandez-Galindo, Canton, MI (US); Daniel Roberts, Livonia, MI (US); Alexey Konstantinov, Dearborn, MI (US); David Doman, Canton, MI (US)

(21) Appl. No.: 18/652,056

(22) Filed: May 1, 2024

(51) Int. Cl. H01M 50/519; H01M 10/42; H01M 10/6554; H01M 50/249; H01M 50/569

(52) U.S. Cl. CPC H01M 50/519; H01M 50/249; H01M 2010/4271; H01M 10/6554; H01M 50/569

(57) ABSTRACT

Systems are provided for a coupling device for an electric system. In one example, a system includes a plurality of arrays interconnected via a plurality of connections. Each of the plurality of connections is coupled to neighboring arrays of the plurality of arrays. The plurality of arrays is spaced apart from one another and do not touch.

### FIELD

The present description relates generally to system for a battery system of an electrified vehicle.

### BACKGROUND/SUMMARY

Batteries are present in an increasing number of vehicles to provide electrical capabilities in an effort to decrease fuel consumption. Electrification of vehicles may present certain difficulties, such as packaging difficulties due to the inclusion of a second energy system.

In one example, the issues described above may be addressed by an assembly including a first array comprising a plurality of battery cells, a second array comprising a plurality of battery cells, and a connection between only the first array and the second array, the connection coupled to an external electric contact of the first array and the second array. In this way, an organization of the assembly may be enhanced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 shows an example of a vehicle system.

FIG. 2 shows a connection including a flexible printed circuit (FPC).

FIGS. 3A, 3B, 3C, 3D, and 3E show a detailed view of the FPC and its connection with multiple arrays.

FIG. 4 shows an internal routing of a daisy chain signal circuit within a single array.

FIG. 5 shows a plurality of jumper harnesses for connecting multiple arrays.

FIG. 6 shows a single jumper harness for connecting neighboring arrays.

FIG. 7 shows a rigid harness for connecting arrays.

FIGS. 8A and 8B show embodiments for an integrated contact patch for connecting with a FPC.

### DETAILED DESCRIPTION

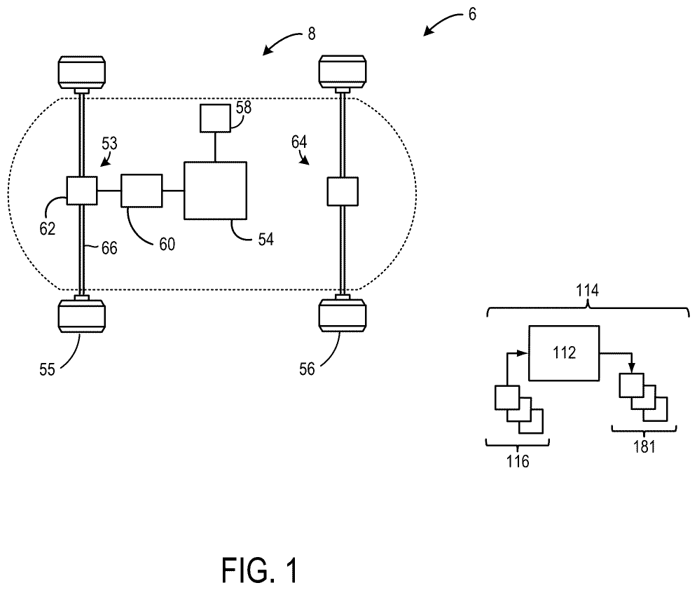

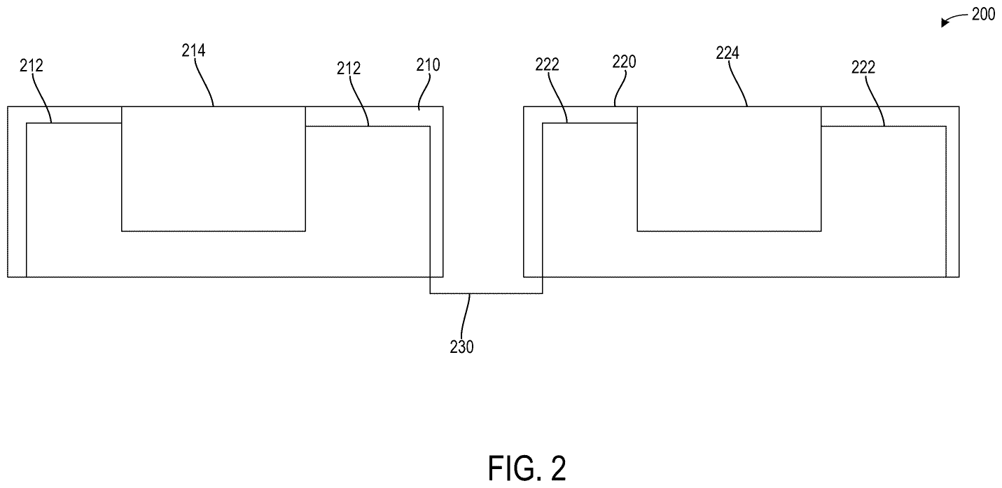

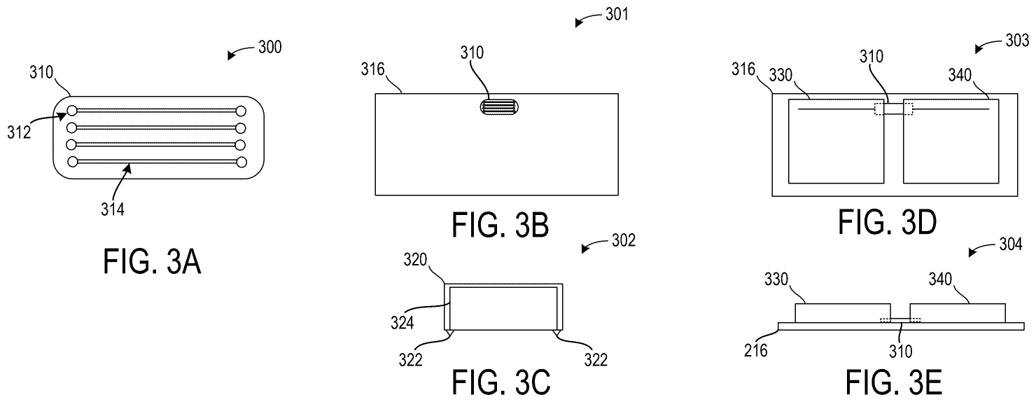

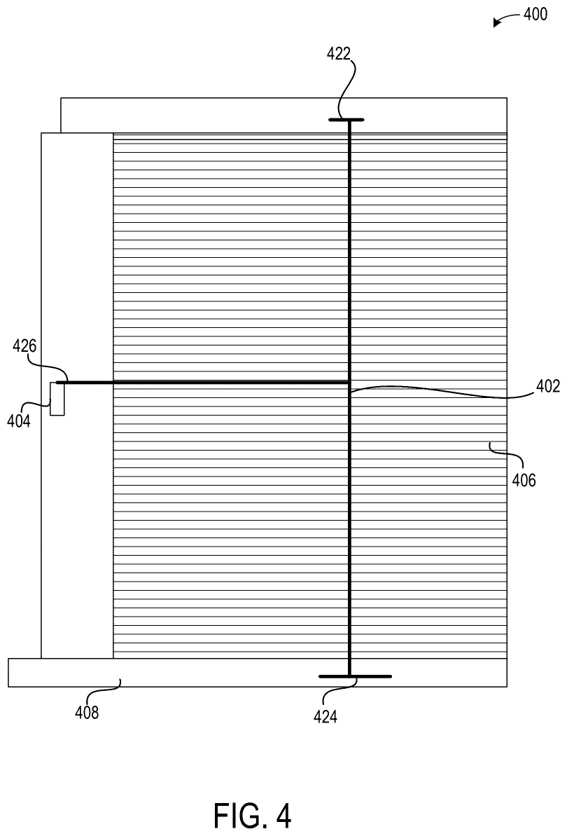

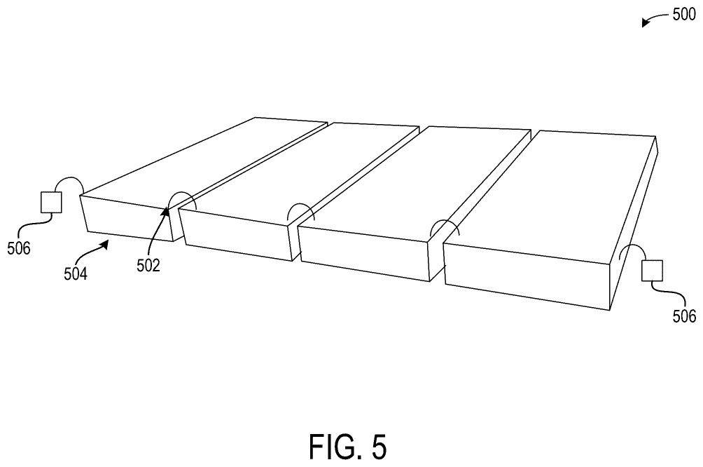

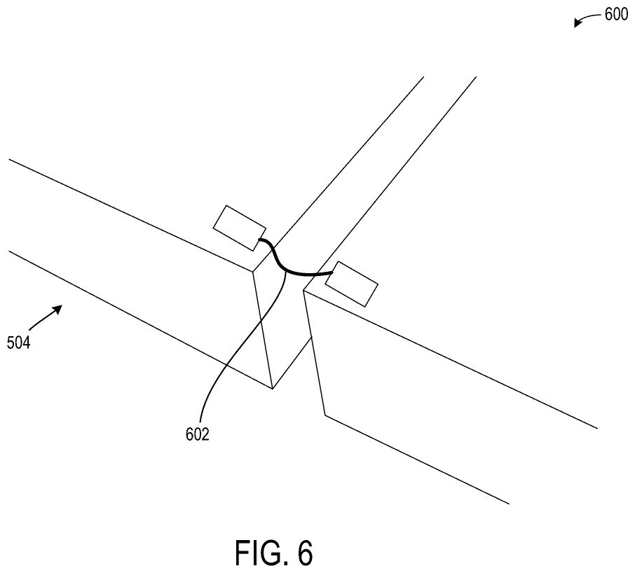

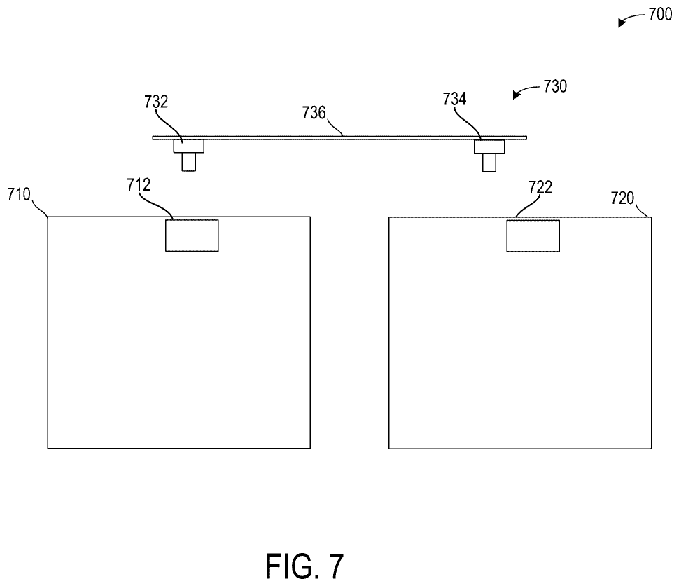

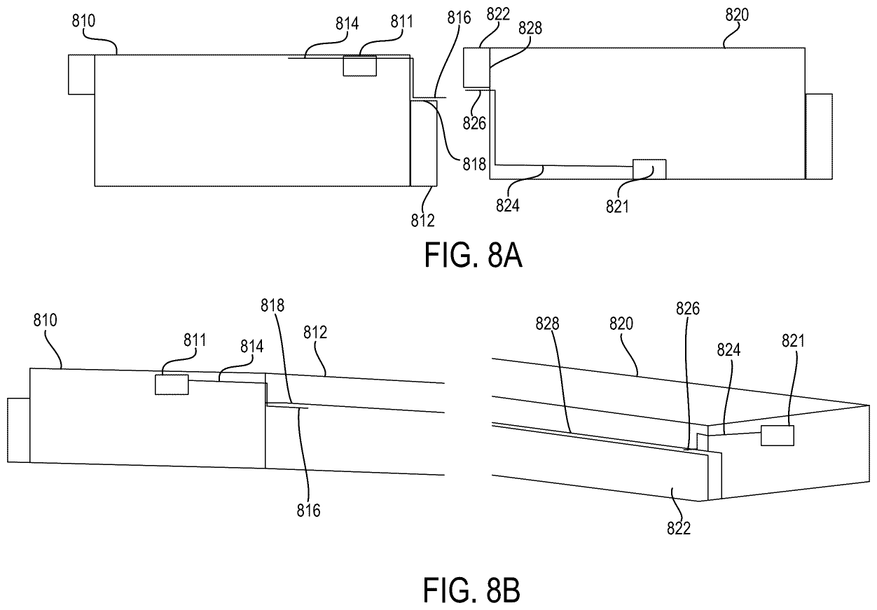

The following description relates to systems for connecting arrays of a battery system of a vehicle. FIG. 1 shows an example of a vehicle system. FIG. 2 shows a connection including a flexible printed circuit (FPC). FIGS. 3A-3E show a detailed view of the FPC and its connection with multiple arrays. FIG. 4 shows an internal routing of a daisy chain signal circuit within a single array. FIG. 5 shows a plurality of jumper harnesses for connecting multiple arrays. FIG. 6 shows a single jumper harness for connecting neighboring arrays. FIG. 7 shows a rigid harness for connecting arrays. FIGS. 8A and 8B show embodiments for an integrated contact patch for connecting with a FPC.

FIG. 1 shows a schematic depiction of a vehicle 6 with a powertrain 8 that may include a prime mover 54 and a transmission 60. The vehicle 6 may be a passenger vehicle, a commercial vehicle, a heavy-duty vehicle, an off-highway vehicle, an agricultural vehicle, a plane, a boat, or other vehicle system that utilizes lubricant.

The prime mover 54 may be electrically connected to an energy storage device 58 (e.g., one or more traction batteries, capacitors, fuel cells, combinations thereof, and the like). Further, the prime mover 54 may be configured to operate as a generator, during selected conditions, to provide electrical power to charge the energy storage device 58, for example.

In some examples, the vehicle 6 may include an internal combustion engine (ICE) configured to operate in combination with or independently of the prime mover 54. In this way, the vehicle 6 may be configured as a hybrid vehicle in some examples.

In the illustrated example, the transmission 60 delivers mechanical power to a differential 62 of an axle assembly 53. However, it will be appreciated that the transmission 60 may additionally or alternatively deliver mechanical power to the other axle 64 in the vehicle 6. Still further, in other examples, the transmission may be incorporated into one of the axles to form an electric axle assembly. In the electric axle example, an internal combustion engine may provide mechanical power to the other axle, in some cases. The axle assembly 53 may include a lubrication system, as will be described in greater detail below.

The transmission 60 (e.g., a gearbox) may be configured to receive torque from the prime mover 54 via a shaft (e.g., a drive shaft) and/or other suitable mechanical components. The transmission 60 may output torque to the differential 62. The output torque may be moderated based on selective adjustments to gear engagement at the transmission 60 to accommodate desired vehicle operation. Torque from the transmission 60 may drive rotation of the differential 62, which may in turn drive rotation of axle shafts 66 which are rotationally coupled to vehicle wheels 55. Vehicle wheels 56 may rotate when vehicle wheels 55 are rotating against a surface.

A controller 112 may form a portion of a control system 114. The control system 114 is shown receiving information from sensors 116 and sending control signals to actuators 181. As one example, the sensors 116 may include sensors such as a battery level sensor, a clutch activation sensor, one or more positions sensors of the electric motor, etc. The controller 112 may receive input data from the sensors, process the input data via a processor, and trigger the actuators in response to the processed input data based on instruction or code programmed therein corresponding to one or more routines.

Turning now to FIG. 2, it shows an embodiment 200 of a first array 210 coupled to a second array 220 via an interlinking connection 230. The embodiment 200 may further include a first circuit 212 integrated into the first array 210 and a second circuit 222 integrated with the second array 220. The first circuit 212 may be connected to a printed circuit board (PCB) 214 of the first array 210. The second circuit 222 may be connected to a second PCB 224 of the second array 220.

The first PCB 214 and the second PCB 224 may be positioned such that array contacts with interface with a PCB contact patch when the arrays are installed. The first circuit 212 and the second circuit 222 may extend through a pack tray, a cross-member, a cold plate, or other structure of the array via the first PCB 214 and the second PCB 224, respectively.

In some examples, additionally or alternatively, pogo pins or other movable contacts may be arranged on the first array 210 and the second array 220 to connect to the first PCB 214 and the second PCB 224, respectively. Additionally or alternatively, the connection to the PCB may be established via a connector.

The interlinking connection 230 may connect to the first circuit 212 and the second circuit 222. In one example, the interlinking connection 230 may curve and/or bend when coupled to the first circuit 212 and the second circuit 222. Due to a length of the interlinking connection 230, the connection may not sag, twist, or bend due to its short length and a mount, a clip, or other fastening device may not be used. In this way, a complexity of installing and connecting the first array 210 and the second array 220 may be decreased.

Turning now to FIG. 3A, it shows an embodiment 300 a flexible printed circuit board (FPC) 310. The FPC 310 may include a plurality of contact patches 312. A trace 314 may be arranged between corresponding contact patches of the plurality of contact patches 312. In the example of FIG. 3A, the plurality of contact patches 312 is arranged in two columns and four rows, each column including an equal number of the plurality of contact patches 312. The trace 314 connects two of the plurality of contact patches 312 of a shared row. In this way, the trace 314 and others of a plurality of traces are connected to two of the contact patches 312 within a common row. The FPC 310 may include other numbers of contact patches and traces to meet different application demands.

An opposite surface of the FPC 310 may be free of the plurality of contact patches 312 and plurality of traces. The opposite surface may include an adhesive configured to physically couple the FPC 310 to a cold plate 316, as shown in example 301 of FIG. 3B.

FIG. 3C shows an example 302 of an array 320. The array 320 may include a plurality of pins 322 coupled to a circuit 324. The plurality of pins 322 may extend outwardly from the array 320. In this way, the plurality of pins 322 may be outside the array 320. The plurality of pins 322 may be pointed, in one example. The plurality of pins 322 may be shaped such that each pin of the plurality of pins 322 may be inserted into a contact patch of the plurality of contact patches 312.

FIG. 3D shows an example 303 of a first array 330 and a second array 340 coupled to the FPC 310. The first array 330 and the second array 340 may be identical to the array 320 of FIG. 3C. In one example, pins of a plurality of pins of the first array 330 may be coupled to the plurality of contact patches 312 in a first column and pins of a plurality of pins of the second array 340 may be coupled to the plurality of contact patches 312 in a second column. The plurality of traces may provide a communication linkage between the first array 330 and the second array 340.

FIG. 3E shows an example 304 of a side-on view of the cold plate 216 including the FPC 310 coupled to the first array 330 and the second array 340.

Turning now to FIG. 4, it shows an example 400 of an internally routed circuit 402 in a single array. The circuit 402 may extend from a PCB 404, along a battery cell support 406, and toward an array housing 408. In one example, the circuit 402 may form a T-shape, wherein a first end 422 is an input end, a second end 424 is an output end, and a third end 426 is coupled to the PCB 404.

FIGS. 5 and 6 show embodiments 500 and 600, respectively, of a plurality of jumper wires 502 configured to interconnect neighboring battery arrays 504 to a battery management system (BMS) 506. A jumper wire 602 of the plurality of jumper wires 502 is shown in FIG. 6. The jumper wire 602 may be a short wire harness configured to connect the battery arrays 504 to one another and the BMS 506. The jumper wire 602 may be a connection between neighboring arrays or between an array and the BMS. The jumper wire 602 may not contact other of the plurality of jumper wires 502. Each array of the battery arrays 504 may include two headers for connecting to the jumper wire 602 to neighboring arrays of the battery arrays 504. Due to the proximity of the battery arrays 504, a retention system (such as a mount or clip) may not be included to retain the jumper wire 602 extending the short distance between neighboring battery arrays 504.

In one example, a first jumper wire (e.g., a first connection) only connects a first array to the BMS. A second jumper wire (e.g., a second connection) only connects the first array to a second array. The second jumper wire is spaced away from and does not touch the first jumper wire. The first array and the second array may touch one another or be spaced away from one another. A third jumper wire (e.g., a third connection) only connects the second array to a third array. The third jumper wire may be spaced away from each of the first and second jumper wires. Each of the jumper wires may be coupled to opposite sides of a respective array. The jumper wires may interface with a contact point, such as a port or external electrical contact, of the arrays. The jumper wires may not crisscross, interweave, or wrap around one another. In this way, use of the jumper wire and other connections of the disclosure may decrease complexity when configuring an electric system of a vehicle.

Turning now to FIG. 7, it shows an example 700 including a first array 710 and a second array 720. The first array 710 may include a first port 712 and the second array 720 may include a second port 722. A connector 730 may include a first connection 732 and a second connection 734 coupled to a same side of a circuit board 736. In one example, the circuit board 736 is rigid. The first connection 732 may engage with the first port 712 and the second connection 734 may engage with the second connection 734. The engagement may be an insertion, a threading, a clamping, a compression, or a combination thereof. The engagement may further provide communication through the first connection 732 and the second connection 732 to the circuit board 736, which may be further coupled to a BMS or additional array.

Turning now to FIGS. 8A and 8B, they show an example of a cross-member integrated contact patch for a plurality of arrays. A first array 810 may include a circuit 814 internally routed toward a first cross-member 812 from a circuit board 811. A contact patch 816 is arranged on a shelf 818 of the first cross-member 812.

A second array 820 may include a circuit 824 internally routed toward a second cross-member 822. A contact patch 826 is arranged on a shelf 828 of the second cross-member 822. The shelf 828 may interface with the shelf 818 such that the contact patch 826 couples to the contact patch 816.

In one example, the first array 810 is identical to the second array 820. The cross-member may include two bodies, a first body arranged on a first longitudinal side and a second body arranged on a second longitudinal side. The circuit 814 is internally routed toward the first cross-member 812 (e.g., the first body) and the circuit 824 is internally routed toward the second cross-member (e.g., the second body) from a circuit board 821. In this way, the circuits may be routed to opposite bodies of a cross-member of separate arrays configured to be in contact with one another. A circuit board may be integrated into each of the arrays.

In one example, the contact patch is a contact point arranged on a ledge (e.g., the shelf). The contact patch may be one of a plurality of contact patches used to interconnect ledges of arrays in face-sharing contact with one another. The contact point may be an external electric contact that is coupled to a circuit integrally arranged within the array such that the circuit is not externally accessible. The arrays may stack on one another such that the ledge and their respective contact points are touching, thereby forming a connection between neighboring arrays.

FIGS. 1-8B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2, 4-6, and 8A-8B are shown approximately to scale.

The disclosure also provides support for an assembly, comprising: a first array comprising a plurality of battery cells, a second array comprising a plurality of battery cells, and a connection between only the first array and the second array, the connection coupled to an external electric contact of the first array and the second array. In a first example of the system, a first circuit is coupled to the connection via the external electric contact of the first array, the first circuit integrally arranged in the first array. In a second example of the system, optionally including the first example, a second circuit is coupled to the connection via the external electric contact of the second array, the second circuit is integrally arranged in the second array. In a third example of the system, optionally including one or both of the first and second examples, the connection is a first connection, further comprising a second connection coupling a battery management system to the first array or the second array. In a fourth example of the system, optionally including one or more or each of the first through third examples, the connection comprises a printed circuit board coupled to a cold plate, wherein the first array and the second array are coupled to a plurality of contact patches. In a fifth example of the system, optionally including one or more or each of the first through fourth examples, the first array and the second array comprise a plurality of pins that insert into the plurality of contact patches. In a sixth example of the system, optionally including one or more or each of the first through fifth examples, the first array and the second array neighbor one another in a battery assembly, and wherein the connection is spaced away from other connections between other arrays of the battery assembly. In a seventh example of the system, optionally including one or more or each of the first through sixth examples, the connection is rigid.

The disclosure also provides support for a system, comprising: a battery management system, a plurality of arrays, and a plurality of connections, each configured to couple to only neighboring arrays of the plurality of arrays or to an array of the plurality of arrays and the battery management system. In a first example of the system, neighboring arrays of the plurality of arrays comprise a ledge with a contact patch, and wherein ledges of the neighboring arrays are in face-sharing contact with one another. In a second example of the system, optionally including the first example, each of the plurality of connections is separate from one another. In a third example of the system, optionally including one or both of the first and second examples, the plurality of connections couple to ports of the plurality of arrays and the battery management system. In a fourth example of the system, optionally including one or more or each of the first through third examples, a sensing circuit is integrally arranged in each of the plurality of arrays and coupled to a connection of the plurality of connections. In a fifth example of the system, optionally including one or more or each of the first through fourth examples, the connection comprises a flexible printed circuit board. In a sixth example of the system, optionally including one or more or each of the first through fifth examples, the plurality of arrays and a corresponding connection of the plurality of connections are coupled to a cold plate.

The disclosure also provides support for a system, comprising: a battery pack comprising a plurality of arrays mounted adjacent to one another, a circuit integrally extending through each of the plurality of arrays, wherein the circuit comprises at least one contact point on an external surface of each of the plurality of arrays, and a connection configured to couple neighboring arrays of the plurality of arrays via coupling to the at least one contact point of a first array and to the at least one contact point of a second array. In a first example of the system, cross-members of the plurality of arrays stack on one another. In a second example of the system, optionally including the first example, the at least one contact point is a one of two contact points, and wherein the connection is coupled to only one of the two contact points of each of the first array and the second array. In a third example of the system, optionally including one or both of the first and second examples, the connection is a first connection, further comprising a second connection configured to couple the first array to a battery management system and a third connection configured to couple the second array to a third array. In a fourth example of the system, optionally including one or more or each of the first through third examples, the first connection and the second connection do not touch and are unsupported.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An assembly, comprising:
a first array comprising a plurality of battery cells;
a second array comprising a plurality of battery cells; and
a connection between only the first array and the second array, the connection coupled to an external electric contact of the first array and the second array.

2. The assembly of claim 1, wherein a first circuit is coupled to the connection via the external electric contact of the first array, the first circuit integrally arranged in the first array.

3. The assembly of claim 2, wherein a second circuit is coupled to the connection via the external electric contact of the second array, the second circuit is integrally arranged in the second array.

4. The assembly of claim 1, wherein the connection is a first connection, further comprising a second connection coupling a battery management system to the first array or the second array.

5. The assembly of claim 1, wherein the connection comprises a printed circuit board coupled to a cold plate, wherein the first array and the second array are coupled to a plurality of contact patches.

6. The assembly of claim 5, wherein the first array and the second array comprise a plurality of pins that insert into the plurality of contact patches.

7. The assembly of claim 1, wherein the first array and the second array neighbor one another in a battery assembly, and wherein the connection is spaced away from other connections between other arrays of the battery assembly.

8. The assembly of claim 1, wherein the connection is rigid.

9. A system, comprising:
a battery management system;
a plurality of arrays; and
a plurality of connections, each configured to couple to only neighboring arrays of the plurality of arrays or to an array of the plurality of arrays and the battery management system.

10. The system of claim 9, wherein neighboring arrays of the plurality of arrays comprise a ledge with a contact patch, and wherein ledges of the neighboring arrays are in face-sharing contact with one another.

11. The system of claim 9, wherein each of the plurality of connections is separate from one another.

12. The system of claim 9, wherein the plurality of connections couple to ports of the plurality of arrays and the battery management system.

13. The system of claim 9, wherein a sensing circuit is integrally arranged in each of the plurality of arrays and coupled to a connection of the plurality of connections.

14. The system of claim 9, wherein each of the plurality of connections comprises a flexible printed circuit board.

15. The system of claim 9, wherein the plurality of arrays and a corresponding connection of the plurality of connections are coupled to a cold plate.

16. A system, comprising:
a battery pack comprising a plurality of arrays mounted adjacent to one another;
a circuit integrally extending through each of the plurality of arrays, wherein the circuit comprises at least one contact point on an external surface of each of the plurality of arrays; and
a connection configured to couple neighboring arrays of the plurality of arrays via coupling to the at least one contact point of a first array and to the at least one contact point of a second array.

17. The system of claim 16, wherein cross-members of the plurality of arrays stack on one another.

18. The system of claim 16, wherein the at least one contact point is one of two contact points, and wherein the connection is coupled to only one of the two contact points of each of the first array and the second array.

19. The system of claim 18, wherein the connection is a first connection, further comprising a second connection configured to couple the first array to a battery management system and a third connection configured to couple the second array to a third array.

20. The system of claim 19, wherein the first connection and the second connection do not touch and are unsupported.
